(19) United States
(12) Patent Application Publication
(10) Pub. No.: US 2022/0322271 A1
(43) Pub. Date: Oct. 6, 2022

(54) SYSTEMS AND METHODS FOR MANAGING ANTENNA SYSTEMS

(71) Applicant: Booz Allen Hamilton Inc., McLean, VA (US)

(72) Inventors: Steven Vincent MODICA, Inver Grove Heights, MN (US); Michael Joseph LE TENDRE, Eatontown, NJ (US); Stacy Paul PILGREEN, Chantilly, VA (US)

(73) Assignee: Booz Allen Hamilton Inc., McLean, VA (US)

(21) Appl. No.: 17/221,293

(22) Filed: Apr. 2, 2021

(51) Int. Cl. H04W 60/04; H04W 48/00; H04B 7/024

(52) U.S. Cl. CPC H04W 60/04; H04W 48/17; H04B 7/024

(57) ABSTRACT

Disclosed is a communication system including a network of a plurality of antenna management system (AMS) nodes connected to a common source, each AMS node including an antenna, compute capability, a transceiver, and an AMS module. The antenna is configured to digitize a radio frequency (RF) signal when received by the antenna from the common source to generate digital data. The compute capability is configured to time stamp the digital data and process the time-stamped digital data to determine connectivity options.

### FIELD

Embodiments relate to systems and methods for managing local and/or distributed antenna systems while considering impacting factors.

### BACKGROUND INFORMATION

Conventional planning tools for managing antenna systems are limited to configuring the system, and fail to consider external factors or features of cooperative local and distributed antennas—i.e., there is no system that plans and manages distributed antennas in a cooperative manner. In addition, conventional planning tools do not provide a means to recommend courses of action to work around limitations. For instance, the current state of planning and managing the use of antennas systems does not offer courses of action when scheduling use. Consequently, the planner or operator of conventional systems may not realize that their planned course of action will results in failure, because they need to consider a wide variety of factors and use disparate methods and tools to develop courses of action. The results are often failure to obtain the desired access or signal gain. There are other tools, such as line of sight or weather analysis tools, that can be used, but these are standalone and do not consider using disparate antennas in a cooperative manner.

### SUMMARY

Embodiments relate to a communication system including a network having a plurality of antenna management system (AMS) nodes connected in a distributed manner. Each AMS node has an antenna, compute capability, a transceiver and an AMS module. The antenna is configured to digitize a radio frequency (RF) signal when received by the antenna from a common source to generate digital data. The compute capability is configured to time stamp the digital data. The compute capability is configured to process the time-stamped digital data to determine connectivity options.

Embodiments relate to a communication system having a first remote node, a beyond line of site (BLOS) node, and a network of a plurality of antenna management system (AMS) nodes connected in a distributed manner. The first remote node is configured to communicate with a second remote node via the BLOS node, the first remote node including an antenna compute capability, and a transceiver. The BLOS node is configured as a relay or a repeater, the BLOS node including an antenna, compute capability, and a transceiver. Each AMS node of the network is connected to the second remote node, and each AMS node has an antenna, compute capability, and a transceiver. Each of the first remote node, the BLOS node, and AMS node of the network includes an AMS module. Each antenna is configured to digitize a radio frequency (RF) signal when received by the antenna to generate digital data. Each compute capability is configured to time stamp the digital data. Each compute capability is configured to process the time-stamped digital data to determine connectivity options.

Embodiments relate to a method of managing communications in a communication system including a network having a plurality of antenna management system (AMS) nodes connected in a distributed manner. Each AMS node includes an antenna, compute capability, a transceiver, and an AMS module. The method involves digitizing a radio frequency (RF) signal when received by the antenna from a common source to generate digital data, time stamping the digital data, and processing the time-stamped digital data to determine connectivity options.

The disclosed system and method allows for managing local and/or distributed antenna systems while considering impacting factors. The system can provide feedback on possible corrective courses of action that will work around these limiting factors. A beneficial aspect of the system is consideration and analysis of external factors as well as cooperative antenna use in recommending courses of action to the planner or operator. The inventive system allows the planner or operator to more effectively manage the employment of their system through recommended courses of action that consider, inter alia, environmental factors, cooperation of distributed antennas, crypto keysets, transceiver types, etc. With the consideration of the cooperation of antennas, it is possible to increase signal gain by combining signals from multiple antennas. The system can also recommend system configurations that allow for the benefits of combining signals from multiple antennas or antenna systems to be realized.

In addition, the system allows for automating the management of local and distributed antenna systems, considering factors such as weather, terrain, gain, and platform access. Platforms include, but are not limited to, vehicles, trains, ships, spacecraft, or aircraft. When scheduling or operating the antenna systems, the system can notify the user when access is not possible due to these factors and provide feedback on possible courses of action that will work around limiting factors. The system may automatically implement a course of action, depending on configuration. Key aspects of this method are the consideration of combining antennas in a cooperative manner, the consideration of a set of local and distributed antennas, and the management of planning factors when scheduling or operating antennas.

### BRIEF DESCRIPTION OF THE DRAWINGS

Other features and advantages of the present disclosure will become more apparent upon reading the following detailed description in conjunction with the accompanying drawings, wherein like elements are designated by like numerals, and wherein:

FIG. 1 shows an exemplary communication system for antenna management;

FIG. 2 shows an exemplary implementation of a communication approach generated by an embodiment of the communication system;

FIG. 3 shows another exemplary implementation of a communication approach generated by an embodiment of the communication system; and

FIG. 4 shows an exemplary system architecture diagram for the communication system of FIG. 3.

### DETAILED DESCRIPTION

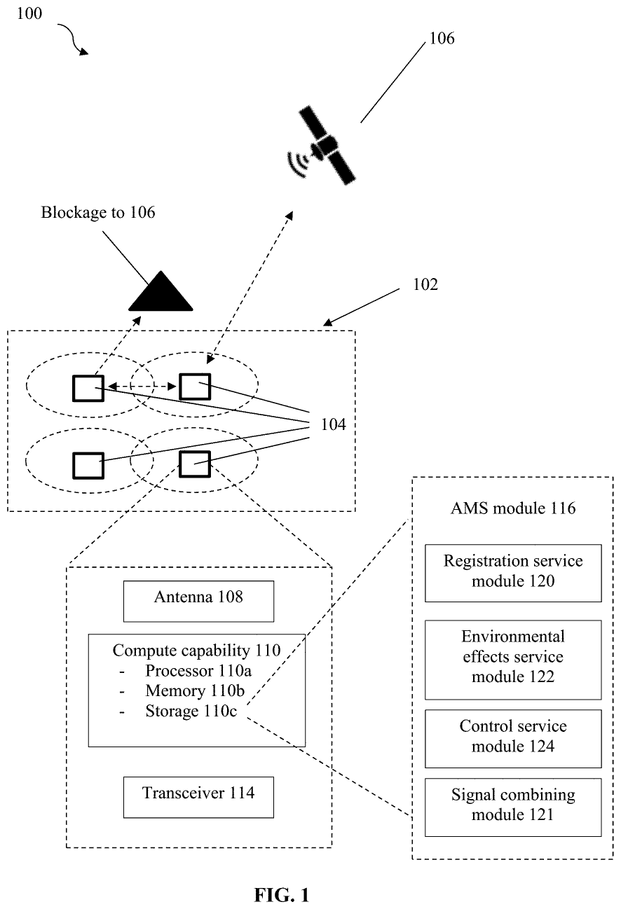

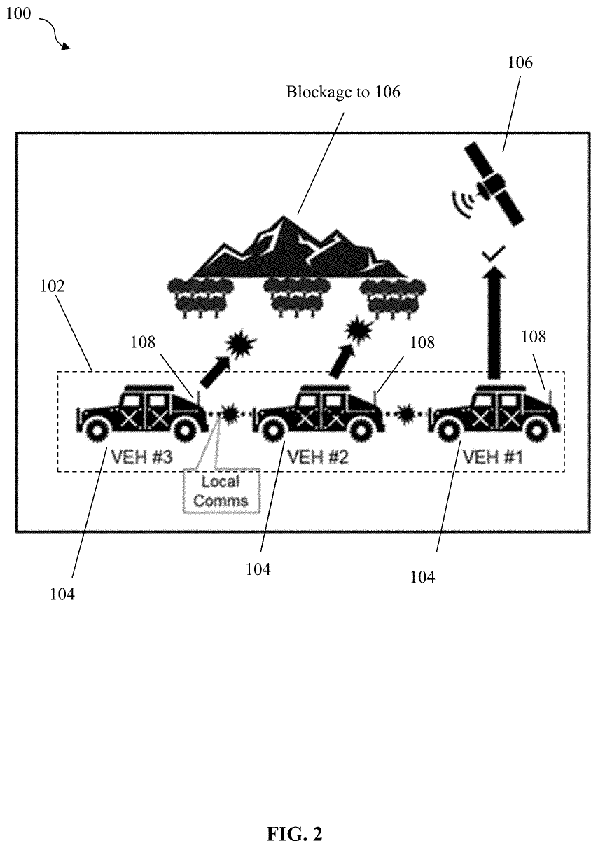

Referring to FIGS. 1-2, an exemplary embodiment relates to a communication system 100 that includes a network 102 having a plurality of AMS nodes 104 connected in a distributed manner. The plurality of AMS nodes 104 are capable of communicating with a common source 106. In some embodiments, the communication system 100 includes the common source 106. For instance, the common source 106 can be a node within the communication system 100 that transmits or receives communication signals (e.g., radio wave signals) to any one or combination of AMS nodes 104 within the network 102. Exemplary common sources 106 can be a broadcast station, a relay station, a satellite, etc. The common source 106 can have a processor, and antenna, and a transceiver.

The communication system 100 is a collection of AMS nodes 104 interconnected by telecommunications networks and transmission systems that facilitate interconnection and interoperation between the common source 106 and the AMS nodes 104. For instance, the communication system 100 can be structured as a satellite configured to communicate with autonomous or semi-autonomous vehicles to facilitate command and control of the vehicles. The satellite is the common source 106. Each vehicle hosts as an AMS node 104, the plurality of which form the network 102. The satellite (common source 106) transmits and receives communication signals to and from the vehicles (AMS nodes 104). A system for command and control of autonomous or semi-autonomous vehicles is exemplary and not intended to be limiting.

Each AMS node 104 has an antenna 108, compute capability 110 (e.g., a processor 110a, memory 110b, and storage 110c) a transceiver 114, and an AMS module 116. The AMS node 104 is configured to cause the antenna 108 to digitize an RF signal when received by the antenna 108 from the common source 106 to generate digital data. This step can involve the compute capability 110 time stamping the digital data. As will be explained herein, embodiments of the AMS module 116 include an environmental effects service module 122 to assess and/or predict availability or connectivity of the AMS node 104. Embodiments of the AMS module 116 can also include a control service module 124 to control antenna-to-antenna communication and antenna-to-common source communication. The environmental effects service module 122 and the control service module 124 can be used to plan for contacts (e.g., node-to-node connectivity or node-to common source connectivity). This planning can be done ahead of time (e.g., before any of the AMS nodes 104 attempt to establish communication with the common source 106. Thus, if it is desired for one of the AMS nodes 104 to establish communications with the common source, the environmental effects service module 122 and the control service module 124 can determine connectivity options (e.g., determine which AMS nodes 104 within the network 102 to use to facilitate that communication or enhance that communication). The connectivity options include determining a network 102 communication approach between the AMS nodes 104 to allow a particular AMS node 104 to effectively communicate (have adequate connectivity) with the common source 106.

For instance, it may be desired for the satellite (common source 106) to communicate with Vehicle-3 (AMS node 104), but it is predetermined (via the environmental effects service module 122) that Vehicle-3 104 would be unable to connect with the satellite 106 or would have a weak communication signal when connecting to the satellite 106. This no- or low-connectivity may be due to predicted weather conditions, predicted physical obstacles (e.g., buildings), predicted destructive interference, or other factors. The AMS module 116 assesses the signal strength of Vehicle-3 104 and predicts that it will be low (due to predicted weather conditions, predicted route of travel that will place it behind a building or in a parking garage, etc.), and also predicts the signal strength of the other vehicles 104 to determine which one(s) Vehicle-3 104 can use to boost signal strength for Vehicle-3 104 or use to communicate through so as to establish good connectivity to the satellite 106. Software packages can be used to predicting signal strength of a given AMS node 104. With Vehicle-3's 104 signal predicted to be low, the system 100 can plan a contact scheme—i.e., employ Vehicle-1 104 and/or Vehicle-2 104 to assist Vehicle-3 104 establishing connectivity to the common source 106.

In addition, or in the alternative, to the planned contacts (e.g., the ahead-of-time planning), the system 100 may be configured for on-demand connectivity options. Thus, the incoming RF signals may be used as a trigger for determining connectivity options. In such a scenario, after the compute capability 110 time stamps the digital data, the AMS module 116 would then cause the compute capability 110 to process the time-stamped digital data to determine connectivity options. Again, the connectivity options include determining a network 102 communication approach between the AMS nodes 104 to allow a particular AMS node 104 to effectively communicate (have adequate connectivity) with the common source 106.

For instance, it may be desired for the satellite (common source 106) to communicate with Vehicle-3 (AMS node 104), but Vehicle-3 104 is unable to connect with the satellite 106 or has a weak communication signal when connecting to the satellite 106. This no- or low-connectivity may be due to weather conditions, physical obstacles (e.g., buildings), destructive interference, or other factors. The AMS module 116 assesses the signal strength of Vehicle-3 104 and determines that its connectivity is low, or predicts that it will be low (due to predicted weather conditions, predicted route of travel that will place it behind a building or in a parking garage, etc.), and also assesses or predicts the signal strength of the other vehicles 104 to determine which one(s) Vehicle-3 104 can use to boost signal strength for Vehicle-3 104 or use to communicate through so as to establish good connectivity to the satellite. As one example, the signal strength at each AMS node 104 can be assessed by measuring the electrical power of the signal received via a power meter. As noted above, other methods can involve software packages that predict signal strength. Such software packages may be more beneficial for advance planning of contacts between the AMS nodes 104 and the common source 106. The signal strength can also be predicted based on the currently and historically assessed signal strengths for Vehicle-3 104, the currently and historically assessed signal strengths of other vehicles in proximity of Vehicle-3 104, and empirical data related to degradation of signal strength (for Vehicle-3 104 and other vehicles 104) when certain weather occurs, when in or behind certain buildings, etc. In addition, or in the alternative to empirical weather data, the system 100 can use planned weather predictions to perform such signal strength predictions.

When the AMS module 116 assesses or predicts Vehicle-3 104 to have no- or low-connectivity (due to no- or low-signal strength), the system 100 then evaluates the assessed or predicted signal strengths of Vehicle-1 104 and/or Vehicle-2 104 to determine if they can be used as part of a communication approach to boost the signal of Vehicle-3 104 or allow Vehicle-3 104 to use other vehicles 104 to establish connectivity to the satellite 106. Suppose the signal strength of Vehicle-1 104 is sufficient and/or is predicted to be sufficient for the time period at which it is desired for Vehicle-3 104 to communicate with the satellite 106. The system 100 can then have Vehicle-3 104 establish communication with Vehicle-2 104 and Vehicle-2 104 establish communication with Vehicle-1 104, wherein Vehicle-1 104 communicates with the satellite 106 and transmits signals to Vehicle-3 104 via Vehicle-2 104. This can be done by establishing a communication link between Vehicle-1 104, Vehicle-2 104, and Vehicle-3 104 so that Vehicle-3 104 can communicate with the satellite via Vehicle-1 104.

Alternatively, the system 100 can have Vehicle-3 104 communicate with the satellite 106 but have its signal strength improved by Vehicle-1 104 so as to increase the signal strength with which Vehicle-3 104 is using to communicate with the satellite 106. For example, this can be done by having Vehicle-3's 104 and vehicle-1's antennas 108 pointed in a same direction (e.g., towards the satellite 106). In this scenario, the AMS modules 116 for each Vehicle 3 104 and Vehicle-1 104 node can combine the digital RF signals of the two nodes 104 to increase the signal strength via a signal combining module 121. Although, combination of the digital RF signals may be preferred, another option can be the use of a combiner or coupler to combine the two antennas, thereby increasing signal path and effectively increasing signal strength.

As noted herein, various components of the communication system 100 have antennas 108, compute capability 110 (e.g., processor 110a, memory 110b, and storage 110c), transceivers 114, and AMS modules 116. Any of the antennas 108 discussed herein can be any device that, during transmission, receives electric current in the form of signals and radiates the energy from the electric current as electromagnetic waves. The antenna 108, during reception, receives electrical power of an electromagnetic wave signal to generate an electric current, which can be processed to derive signals therefrom. The antenna 108 also digitizes the RF signal to generate digital data. Other components such as digitizers, switches, filters, receivers, amplifiers, etc. can be used to facilitate proper operation of the antenna 108. Any of the processors 110a discussed herein can be hardware (e.g., processor, integrated circuit, central processing unit, microprocessor, core processor, computer device, etc.), firmware, software, etc. configured to perform operations by execution of instructions embodied in algorithms, data processing program logic, automated reasoning program logic, etc. It should be noted that use of computer devices herein includes Graphics Processing Units (GPUs) and Field Programmable Gate Arrays (FPGAs). It is contemplated for these, along with Central Processing Units (CPUs), to do most of the heavy work. Any of the memory 110b discussed herein can be computer readable memory configured to store data. The memory 110b can include a non-volatile, non-transitory memory (e.g., as a Random Access Memory (RAM)), and be embodied as an in-memory, an active memory, a cloud memory, etc. Embodiments of the memory can include a processor module and other circuitry to allow for the transfer of data to and from the memory, which can include to and from other components of the communication system 100. This transfer can be via hardwire or wireless transmission. Any of the transceivers 114 discussed herein can be used in combination with switches, receivers, transmitters, routers, gateways, wave-guides, etc. to facilitate communications via a communication approach that facilitates controlled and coordinated signal transmission and processing to any other component or combination of components of the system 100. The transmission can be via a communication link. The communication link can be electronic-based, optical-based, opto-electronic-based, quantum-based, etc. The AMS module 116 is a software module within the storage of the compute capability 110 and configured to cause a compute capability 110 to execute functions that will carry out the process steps described herein.

In addition, any of the components can have an application programming interface (API) and/or other interfaces configured to facilitate a computer in communication with the communication system 100 executing commands and controlling aspects of any one or combination of components. For example, an embodiment of the communication system 100 can include a computer (e.g., a server, a mainframe computer, a desk top computer, a laptop computer, a tablet, a smartphone, etc.) configured to be in communication with any one or combination of components of the communication system 100. The computer can be programmed to generate a user interface configured to facilitate control of and display of various operational aspects of the communication system 100, including operational aspects of any component of the communication system 100. In addition, the computer can be operatively associated with memory (e.g., a database) to store data related to registration of AMS nodes 104, historical data about connectivity of AMS nodes 104, signal strengths of AMS nodes 104 correlated with weather conditions, times of day, location, etc., weather prediction data, actual or planned movements of the AMS nodes 104, etc.

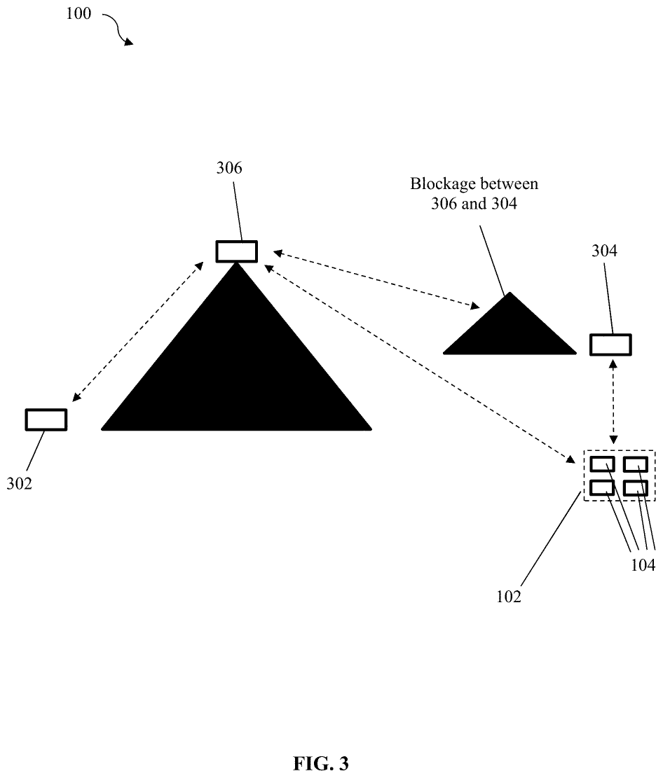

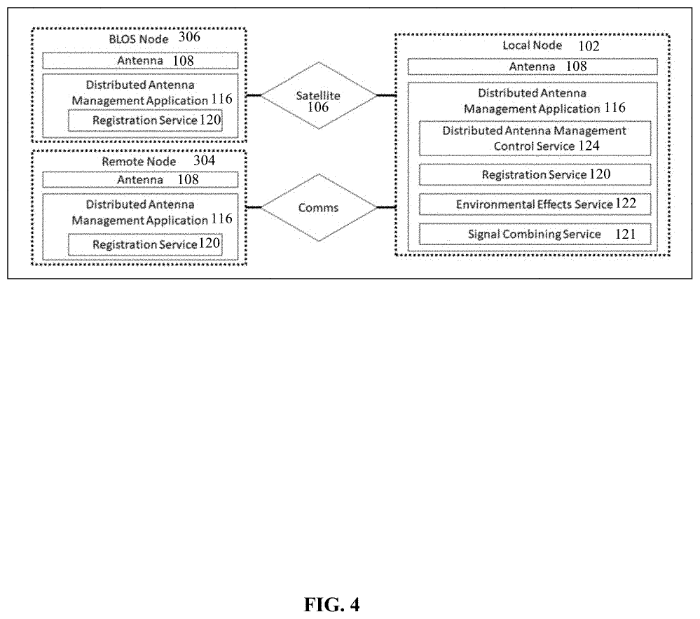

The network 102 is a network of AMS nodes 104, each node 104 having an antenna 108. This network 102 can operate as a distributed network or a local network. A distributed network can be a network of spatially separated AMS nodes 104 connected in a distributed manner. The AMS nodes 104 can be in communication with a common source 106 to provide communications within a geographic area of the spatially separated AMS nodes 104. A local network can be an AMS node 104 or AMS nodes 104 within proximity to a remote node. For instance, as shown in FIGS. 3-4, and as will be explained later, aspects of the communication system 100 can facilitate communication between a first remote node 302 and a second remote node 304, wherein the first and second remote nodes 302, 304 are in communication with each other via a beyond line of site node 306. The beyond line of site node 306 can be a repeater, for example. Suppose the second remote node 304 is predicted to have no- or low-signal strength (or has no- or low-signal strength) with the beyond line of site node 306. The system 100 can then use an AMS node 104 of a local a network 102 that is in proximity with the second remote node 304 to allow the second remote node 304 to communicate with the beyond line of site node 306 using the methods described herein.

Referring to FIGS. 1 and 4, embodiments of the AMS module 116 include a registration service module 120 configured to register and track presence of AMS nodes 104 for inclusion into the network 102 based on reachability of another AMS node 104. The registration of an AMS node 104 and the communication approach (rules, syntax, semantics, and synchronization of communication) for each AMS node 104 can be determined based on any one or combination of antenna type, antenna make, antenna model, antenna unique identifier number/code, antenna speed (if mobile), antenna orientation, elevation and angle off of level, antenna operating frequency, antenna operating bandwidth, antenna capacity metrics, antenna scheduled utilization, antenna location, antenna polarization, transceiver characteristics, crypto keysets, etc. Additional antenna inputs/variables may be used for calculating a predicted signal strength, access, gain, interference, virtual limitations, utilization capacity, etc. These can include pitch, yaw, and roll impacting the antenna gain. A GPS can provide many of these parameters, for example. Additionally, the unique ID may be important for network management, anti-spoofing, subscription and registration services, etc. Thus, when the control service module 124 determines which AMS node(s) 104 to select for establishing or improving connectivity, it can also factor in these variables. Registration data can be stored with the compute capability 110.

In some embodiments, the AMS module 116 can include an environmental effects service module 122 configured to assess availability or connectivity of the AMS node 104 by factoring any one or combination of: current or predicted weather conditions for the AMS node 104, line-of-sight between the AMS node 104 and the common source 106, or calculated gain for the AMS node 104. The environmental effects service module 122 can obtain data about: connectivity of AMS nodes 104; signal strengths of AMS nodes 104 correlated with weather conditions, times of day, location, etc.; weather prediction data (from outside sources); actual or planned movements of the AMS nodes 104; or more. The environmental effects service module 122 can send this data to a data store and pull from this data store to allow the control service module 124 to select an optimal AMS node 104 and develop an optimal communication approach.

In some embodiment, the AMS module 116 can include a control service module 124 configured to control antenna-to-antenna communication and antenna-to-common source communication. The control service module 124 uses information from the registration service module 120 (which determines reachability of antennas 108 of other AMS nodes 104) and the environmental effects service module 122 (which determines the environmental factors affecting availability and connectivity of other AMS nodes 104) to determine if a scheduled contact with the common source 106 can be made by an AMS node 104, or, if not, can another AMS node(s) 104 can make the desired contact with the common source 106. As a result of this determination, the control service module 124 recommends a course of action (e.g., recommends which AMS nodes(s) 104 to use). This course of action is the communication approach. An operator of the system 100 can implement that course of action. In the alternative, the system 100 can use the control service module's 124 recommendation and automatically implement the course of action. Thus, control service module 124 is configured to develop the communication approach to mitigate or eliminate antenna performance issues and/or antenna-to-common source connection issues.

As noted above, the communication approach can be generated and displayed via a user interface as a recommendation to an operator for mitigating or eliminating antenna performance issues and/or antenna-to-common source connection issues. The recommendation can be displayed via a user interface to allow a user to view the communication approach. A user can then, via the user interface, implement the communication approach. In some embodiments, the control service module 124 sends a plurality of communication approaches, each providing a connectivity option. These can be ranked by the AMS module 116 to provide a user as assessment of the efficacy of implementing each communication approach. The efficacy can be measured by a signal gain to be obtained, a signal strength to be obtained, a time period for which the signal gain or signal strength will be available, the amount of component resources (e.g., how many AMS nodes 104 are needed), etc. if the communication approach is implemented.

The system 100 can be configured to implement the communication approach to mitigate or eliminate antenna performance issues and/or antenna-to-common source connection issues. For instance, once a user selects the recommended communication approach, the system 100 sends signals to the compute capability 110 of the appropriate AMS nodes 104 to implement the communication approach.

As noted above, the AMS module 116 assesses the availability or connectivity of an AMS node 104. In this regard, the AMS module 116 can be configured to assess a signal strength of an RF signal between the antenna 108 and the common source 106. In addition, or in the alternative, the AMS module 116 is configured to predict a signal strength of an RF signal to occur between the antenna 108 and the common source 106. For instance, when it is desired for Vehicle-1 104 to communicate with the satellite 106, the RF signal between the antenna 108 for Vehicle-1 104 and the satellite 106 is assessed. In addition, or in the alternative, the AMS module 116 invokes the environmental effects service module 122 to predict what the RF signal strength will be for the AMS node 104 of Vehicle-1. Suppose it is desired for Vehicle-1 104 to communicate with the satellite 106 three hours from now, or after it moves to location A, or at some other time in the future. The environmental effects service module 122 can pull environmental data pertaining to this time-space coordinate and use it to allow the control service module 124 to develop an optimal communication approach, the optimal being highest ranked communication approach of a plurality of communication approaches developed. Alternatively, the control service module 124 generates a plurality of communication approaches, each with a ranking, and presents the plurality of ranked communication approaches to an operator to allow the operator to select a communication approach to implement.

As another example, suppose it is desired for Vehicle-1 104 to establish communication with the satellite 106 in 3 hours and maintain that communication during the time-space coordinates corresponding to Vehicle-1 104 travelling from location A to location B. The environmental effects service module 122 can pull environmental data pertaining to this time-space duration and use it to allow the control service module 124 to develop an optimal communication approach or a plurality of ranked communication approaches for this time-space duration.

The assessment or prediction of signal strength is not limited to just the AMS node 104 for which it is desired to have a communication with the common source 106. For instance, the plurality of AMS nodes 104 of the network 102 can include a first AMS node 104 having a first AMS module 116, a first control service module 124, and a first antenna 108. The network 102 can also have a second AMS node 104 having a second AMS module 116, a second control service module 124, and a second antenna 108. The first AMS module 116 (or second module 116) can be configured to assess or predict a signal strength of an RF signal between the first antenna 108 (or second antenna 108) and the common source 106—e.g., the control service module 124 of the first AMS node 104 (or second AMS module 104) can acquisition environmental information from the environmental effects service module 122 of the first AMS node 104 (or second AMS node 104). In addition, or in the alternative, the first AMS module 116 (or second AMS module 116) can be configured to assess or predict a signal strength of an RF signal between the second antenna 108 (or first antenna 108) and the common source 106—e.g., the control service module 124 of the first AMS node 104 (or second AMS node 104) can acquisition environmental information from the environmental effects service module 122 of the second AMS node 104 (or first AMS node 104).

As a more general matter, the AMS module 116 for each AMS node 104 can be configured to assess or predict a signal strength of an RF signal between any one or more of the plurality of antennas 108 and the common source 106.

The assessment of the signal strength can be assessing the measured signal strength or predicted signal strength to a threshold signal strength. For instance, the control service module 124 for each AMS node 104 can be configured to assess and/or predict a signal strength of an RF signal between any one or more of the plurality of antennas 108 and the common source 106. The control service module 124 is also configured to: control antenna-to-antenna communication and antenna-to-common source communication and develop a communication approach to mitigate or eliminate antenna performance issues and/or antenna-to-common source connection issues. When a signal strength between a first AMS node 104 of the plurality of AMS nodes 104 and the common source 106 is assessed or predicted to be below a threshold signal strength, the control service module 124 develops a communication approach. This communication approach is a selection of a second AMS node 104 of the plurality of AMS nodes 104 having an assessed or predicted signal strength that is equal to or greater than the threshold signal strength to communicate with the common source 106, wherein the first AMS node 104 communicates with the common source 106 via the second AMS node 104. Alternatively, this communication approach selects a second AMS node 104 of the plurality of AMS nodes 104 such that a combined RF signal of the first AMS node 104 and the second AMS node 104 has an assessed or predicted signal strength that is equal to or greater than the threshold signal strength, wherein the first AMS node 104 communicates with the common source 106 via the combined RF signal of first and second AMS nodes 104. The communication approach could also select multiple second AMS nodes 104 to combine with the first AMS node 104. As a non-limiting example, suppose communications for a certain scenario can occur within a range from −110 dB to −50 dB. The threshold signal strength can then be −110 dB, −100 dB, −90 dB, −80 dB, −70 dB, −60 dB, −50 dB or any value there-between. The selection of the threshold signal strength can be based on design and operational criteria for a given situation.

As noted above, other factors are considered besides signal strength. For instance, suppose a communication approach of using Vehicle-2 104 provides a signal strength of dB-1 but only for a small window of time (due to imminent weather conditions), after which is it predicted that it will fall to dB-2. Suppose a different communication approach using Vehicle-3 104 provides a signal strength of dB-3 but for a longer period of time, and Vehicle-1 104 needs to communicate with the satellite for that longer period of time. The system 100 would factor this in and use or recommend the latter communication approach. Alternatively, the system 100 can use or recommend the former communication approach for the limited period of time and then switch to or recommend the latter communication approach after that limited period of time.

As noted above, the system 100 can be configured to automatically implement the recommended communication approach generated by the control service module 124. In addition, or in the alternative, the control service module 124 can be configured to transmit a message that is the recommendation for display via a user interface.

As yet another example, the AMS module 116 for each AMS node 104 is configured to assess and/or predict a signal strength of an RF signal between any one or more of the plurality of antennas 108 and the common source 106. The AMS module 116 for each AMS node 104 includes a control service module 124 configured to: control antenna-to-antenna communication and antenna-to-common source communication and develop a communication approach to mitigate or eliminate antenna performance issues and/or antenna-to-common source connection issues. When a signal strength between a first AMS node 104 of the plurality of AMS nodes 104 and the common source 106 is assessed or predicted to be below a threshold signal strength, the control service module 124 develops a communication approach. This communication approach is a selection any one or more of the AMS nodes 104 of the plurality of AMS nodes 104 having an assessed or predicted signal strength that is equal to or greater than the threshold signal strength to communicate with the common source 106, wherein the first AMS node 104 communicates with the common source 106 via the selected any one or more AMS nodes 104, In addition, or in the alternative, this communication approach selects any one or more of the AMS nodes 104 of the plurality of AMS nodes 104 such that a combined RF signal of the first AMS node 104 and the selected any one or more AMS nodes 104 has an assessed or predicted signal strength that is equal to or greater than the threshold signal strength, wherein the first AMS node 104 communicates with the common source 106 via the combined RF signal of first AMS node 104 and the selected any one or more antennas nodes 104.

In some embodiments, the AMS module 116 for each AMS node 104 is configured to continuously, periodically, or at a scheduled time assess and/or predict a signal strength of an RF signal between any one or more of the plurality of AMS nodes 104 and the common source 106.

Referring to FIGS. 3-4, another exemplary embodiment of a communication system 100 includes a first remote node 302, a second remote node 304, a beyond line of site (BLOS) node 306, and a network 102. The first remote node 302 is configured to communicate with the second remote node 304 via the BLOS node 306. The first and second remote nodes 302, 304 each includes an antenna 108, compute capability 110, and a transceiver 114. The BLOS node 306 may be configured as a relay or a repeater, for example. The BLOS node 306 includes an antenna 108, compute capability 110, and a transceiver 114. The network 102 includes a plurality of AMS nodes 104 connected to the second remote node 304, each AMS node 104 including an antenna 108, compute capability 110, and a transceiver 114. Each of the first remote node 302, the BLOS node 306, and AMS node 104 of the network 102 includes an AMS module 116. In some embodiments, the second remote node 304 also includes as AMS module 116. Each AMS module 116 is configured to cause its associated antenna 108 to digitize an RF signal when received by its associated antenna 108 to generate digital data. Each compute capability 110 of each AMS module 116 is configured to time stamp the digital data. Each control service module 124 of each AMS module 116 is configured to process the time-stamped digital data to determine connectivity options based on environmental data received by the environmental effects service module 122.

Each AMS module 116 includes a control service module 124 configured to control antenna-to-antenna communication and antenna-to-second remote node communication. The control service module 124 can also be configured to develop a communication approach to mitigate or eliminate antenna performance issues and/or antenna-to-second remote node connection issues.

The control service module 124 for the BLOS node 306 is configured to assess and/or predict a signal strength of an RF signal between the BLOS node 306 and the second remote node 304. Each control service module 124 for each AMS node 104 of the network 102 is configured to assess and/or predict a signal strength of an RF signal between any one or more of the plurality of antennas 108 and the BLOS node 306 as well as the second remote node 304.

When a signal strength between a BLOS node antenna 108 and the second remote node antenna 108 is assessed or predicted to be below a threshold signal strength, the control service module 124 develops a communication approach. That communication approach is a selection of any one or more of antennas 108 from the network 102 having an assessed or predicted signal strength that is equal to or greater than the threshold signal strength to communicate with the second remote node 304, which enables the BLOS node antenna 108 to communicate with the second remote node antenna 108 via the selected any one or more of antennas 108, wherein the first remote node antenna 108 communicates with the second remote node antenna 108 via the BLOS node antenna 108. In addition, or in the alternative, the communication approach is a selection of any one or more of antennas 108 from the network 102 such that a combined RF signal of the BLOS node antenna 108 and the selected network antennas 108 has an assessed or predicted signal strength that is equal to or greater than the threshold signal strength, which enables the BLOS node antenna 108 to communicate with the second remote node antenna 108 via the combined RF signal of the BLOS node antenna 108 and selected antennas 108, and enables the first remote node antenna 108 to communicate with the second remote node antenna 108 via the BLOS node antenna 108.

Additional embodiments relate to a method of managing communications in a communication system including a network 102 having a plurality of AMS nodes 104 connected to in a distributed manner, each AMS node 104 of the plurality of AMS nodes 104 including an antenna 108, a compute capability 110 (e.g., a processor 110a, memory 110b, and storage 110c), a transceiver 114, and an AMS module 116. The method involves digitizing an RF signal when received by the antenna 108 from a common source 106 to generate digital data, time stamping the digital data, and processing the time-stamped digital data to determine connectivity options.

In some embodiments, the method involves registering an AMS node 104 for inclusion into the network 102 can be based on any one or combination of antenna type, antenna make, antenna model, antenna unique identifier number/code, antenna speed (if mobile), antenna orientation, elevation and angle off of level, antenna operating frequency, antenna operating bandwidth, antenna capacity metrics, antenna scheduled utilization, antenna location, antenna polarization, transceiver characteristics, crypto keysets, etc. Additional antenna inputs/variables may be used for calculating a predicted signal strength, access, gain, interference, virtual limitations, utilization capacity, etc. These can include pitch, yaw, and roll impacting the antenna gain. A GPS can provide many of these parameters, for example. Additionally, the unique ID may be important for network management, anti-spoofing, subscription and registration services, etc.

In some embodiments, the method involves assessing availability of connectivity of an AMS node 104 by factoring any one or combination of: current or predicted weather conditions for the AMS node 104; line-of-sight between the AMS node 104 and the common source 106; or calculated gain for the AMS node 104.

In some embodiments, the method involves developing a communication approach to mitigate or eliminate antenna performance issues and/or antenna-to-common source connection issues by controlling antenna-to-antenna communication and antenna-to-common source communication.

In some embodiments, the method involves providing the communication approach via a user interface as a recommendation for mitigating or eliminating antenna performance issues and/or antenna-to-common source connection issues. In addition, or in the alternative, the method involves implementing the communication approach to mitigate or eliminate antenna performance issues and/or antenna-to-common source connection issues. As will be explained herein, the communication system 100 can be passive or active, fixed or mobile. Also, it is agnostic to frequency bands, waveforms, and proprietary communication elements.

In some embodiments, the communication system 100 can be configured to operate as a mesh network. In such instances, sequential communications would not be used. Under a mesh network, antenna 108 parameters can be transmitted and discoverable within the mesh network of antennas 108 so all antennas 108 are able to determine optimal utilizations of available arrays. Certain situations may require a parent/child relationship, but it is contemplated for the configurations to act as a mesh for most scenarios. A subscription type service within a bounded geographic area can be used to exchange antenna 108 metadata to run calculations in near-real time.

Capabilities of the system 100 can be described within a use case, based upon the nodes in FIG. 2. FIG. 2 depicts three vehicles (e.g., three AMS nodes 104), each vehicle having a vehicle-mounted antennas 108. The AMS module 116 is contained in a computing environment within each vehicle. The vehicles have local communications to facilitate communication which each other. Prior to attempting to use the antennas 108, the AMS module's 116 registration service module 120 provides a facility for the nodes 104 to register with each other. This registration service module 120 provides reachability information on the remote nodes 104, as well as characteristics of the antennas 108 and systems on board. This antenna 108 information includes parameters such antenna type and bandwidth supported. Information on system on board includes parameters of transceivers and modems.

Vehicle-3 104 desires to contact the satellite 106, but it is blocked by a terrain feature, in this case a forested mountain. The systems 100 operator within Vehicle-3 104 attempts to schedule the satellite 106 contact. The AMS module 116 on Vehicle-3 104 calculates that the satellite 106 is unreachable, due to the terrain feature. The AMS module 116 then reaches out to registered vehicles 104 and queries their AMS module 116 to determine if they can initiate the contact with the satellite 106. The AMS module 116 in Vehicle-2 104 determines that it also is blocked by the same terrain, and notifies the AMS module 116 in Vehicle-1 104 that it cannot contact the satellite 106. The AMS module 116 in Vehicle-3 104 receives the request from Vehicle-3 104, and runs calculations to ascertain if it can contact the satellite 106. It is not blocked by the terrain, so it the AMS module 116 calculates that it can contact the satellite 106. The AMS module 116 in Vehicle-1 104 notifies the AMS module 116 in Vehicle-3 104 that it can make the satellite 106 contact. The operator in Vehicle-3 104 receives a notification from the AMS module 116 that the satellite 106 contact can be made remotely via Vehicle-1 104, or the AMS module 116 will automatically schedule the desired satellite contact via Vehicle-1. The operator in Vehicle-3 104 then uses the AMS module 116 to schedule the satellite 106 contact, via Vehicle-1 104. This scenario exemplifies the system cooperatively managing multiple antennas 108 to overcome a singular antenna 108 being blocked by terrain. The AMS module 116 will consider terrain blockage, as well as other factors including, but not limited to, weather and antenna gain.

The system's 100 capability of antenna 108 combining can be described in another use case. In this scenario, the antennas 108 in Vehicle-1 104 and Vehicle-2 104 can view a satellite 106, but the satellite 106 is low on the horizon, resulting in antenna gain that is below the gain threshold for successful contact for each singular antenna 108. The system 100 operator in Vehicle-1 104 attempts to schedule a contact for the satellite 106. The AMS module 116 of Vehicle-1 calculates that the gain for the satellite 106 is below the threshold, and notifies the user of the same. The AMS module 116 in Vehicle-1 104 then attempts to remedy the problem. The AMS module 116 in Vehicle-1 104 recognizes that Vehicle-2 104 can see the satellite 106, and that when the signals from Vehicle-1 104 and Vehicle-2 104 are combined, the combined signal has sufficient gain to adequately process the signal. The AMS module 116 of Vehicle-1 is then used to schedule and coordinate the satellite 106 contact across the two vehicles 104. Vehicle-2's 104 data is captured and forwarded to Vehicle-1 104 for combining. The AMS module 116 in Vehicle-1 104 combines the two signals, resulting in a successful contact.

Referring to FIGS. 3-4, a third use case is the use and control of the antennas 108 from a Beyond Line of Site (BLOS) fixed station 306. A fixed station node 306 can be within same geographical region or very distant, but has BLOS network connectivity to a group of local antennas 108. Examples of BLOS network connectivity include, but are not limited to, satellite 106 and multi-hop terrestrial networks including the Internet. The fixed station 306 has the desire to collect communications or some other signals in the local area. The fixed station 104 has used its AMS module 116 and registration service module 120 to register itself with the local antennas 108 of the other nodes, such as first and second remote nodes 302, 304 and the antenna nodes 104 of the network 102. The remote station operator uses the AMS module 116 to schedule a contact. The AMS module 116 recognizes the parameters of the contact and determines that one of the local antennas 108 in the network 102 is available during that timeframe and can successfully make the contact. The AMS module 116 on the fixed station 306 schedules the contact with one of the local nodes 104. One or more of the AMS modules 116 within the local nodes 108 process the contact and forwards the data back to the remote station 306. This remote station 306 use of a local station's antennas 108 may be done overtly or covertly, depending on system configuration. This can be a beneficial aspect of the communication system 100. For instance, the communication system 100 can be used to actively communicate or be used to passively receive only to avoid detection. While in passive receive only mode, once the operational environment allows, active communication can be used again. Also, the communication system 100 can be used for signals intelligence (SIGINT) as a primary mission or as a secondary mission.

The system 100, in this configuration, can include local, remote, Beyond Line of Site (BLOS), and fixed or mobile station nodes 104. All nodes 104 can be configured as peers, and have AMS modules 116, as depicted in a local node in FIG. 4. For discussion purposes, only the AMS and registration service modules 116, 120 are shown in the BLOS and remote nodes 104. In addition to the nodes 104 depicted, there is a fixed station node 104, which may or may not be a host antenna 108, and which can access the local nodes 108, via transport communications networks, through either in-band or out-of-band communications. The fixed station nodes 104 can access the antennas 108 attached to the local node 104. The fixed station 104 can schedule and operate the remote antennas 108. The remote antennas 108 can be used overtly or surreptitiously, as this use is configurable. The fixed node 104 sourced control packets can be in band or out of band. In-band control can use a variety of methods, such as use of packet header fields, or otherwise in-band through the communications channels. The data sent between nodes 104 can include, but is not limited to, raw RF data, raw Intermediate Frequency (IF) data, baseband, or fully resolved data. The type of data is configurable. The raw data can be sent using Radio Frequency over Internet Protocol (RFoIP) protocols, or other sampling methods.

The AMS module 116 containing nodes 104 can all be peers—i.e., there are no control nodes 104 and the management of the antennas systems happens in a distributed manner. System software services of the AMS module 116 includes the registration service module 120, environmental service module 122, a signal combining module 121, and the control service module 124.

The registration service module 120 is a distributed capability that sends registration control packets to nodes throughout the system 100. The nodes 104 register antenna 108 capability and configuration information including, but not limited to, antenna 108 capabilities including, but not limited to, antenna type, antenna make, antenna model, antenna unique identifier number/code, antenna speed (if mobile), antenna orientation, elevation and angle off of level, antenna operating frequency, antenna operating bandwidth, antenna capacity metrics, antenna scheduled utilization, antenna location, or antenna polarization. The registration service 120 module also registers non-antenna information including, but not limited to, transceiver type, transceiver settings, and cryptographic information. The registration service module 120 also continually monitors reachability information of the other nodes 104 having the AMS module 116.

The environmental service module 122 is used to calculate the impacts of environmental effects including, but not limited to, weather, line-of-sight, and gain. This information is calculated from a local point of view and the results communicated with the AMS module 116 initiating the request. An important aspect of the environmental service module 122 is the availability to use current data on hand to determine the availability of contacts in the future. An example of this would be in considering weather affects. A local node 104 may be blocked from access due to future weather predictions, while a remote node 104, geographically distant, may not be affected by the weather at that location, allowing for the local node 104 to schedule the access on the remote node 104, through the system 100.

The control service module 124 manages contacts, manages availability and scheduling, develops, and processes requests for other services within the system 100. It manages work and communications locally and across the system 100 of remote nodes 104. It also provides a user interface to the operator.

It will be understood that modifications to the embodiments disclosed herein can be made to meet a particular set of design criteria. For instance, any of the compute capabilities 110, AMS nodes 104, or any other component of the system 100 can be any suitable number or type of each to meet a particular objective. Therefore, while certain exemplary embodiments of the system 100 and methods of using the same disclosed herein have been discussed and illustrated, it is to be distinctly understood that the invention is not limited thereto but can be otherwise variously embodied and practiced within the scope of the following claims.

It will be appreciated that some components, features, and/or configurations can be described in connection with only one particular embodiment, but these same components, features, and/or configurations can be applied or used with many other embodiments and should be considered applicable to the other embodiments, unless stated otherwise or unless such a component, feature, and/or configuration is technically impossible to use with the other embodiment. Thus, the components, features, and/or configurations of the various embodiments can be combined together in any manner and such combinations are expressly contemplated and disclosed by this statement.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein. Additionally, the disclosure of a range of values is a disclosure of every numerical value within that range, including the end points.

What is claimed is:

1. A communication system, comprising:
a network having a plurality of antenna management system (AMS) nodes connected in a distributed manner, each AMS node including an antenna, compute capability, a transceiver and an AMS module, wherein:
the antenna is configured to digitize a radio frequency (RF) signal when received by the antenna from a common source to generate digital data;
the compute capability is configured to time stamp the digital data; and
the compute capability is configured to process the time-stamped digital data to determine connectivity options.

2. The communication system of claim 1, comprising:
the common source.

3. The communication system of claim 1, wherein:
the AMS module includes a registration service module configured to register the AMS node for inclusion into the network based on reachability of another AMS node.

4. The communication system of claim 1, wherein:
the AMS module includes an environmental effects service module configured to assess availability of the AMS node by factoring any one or combination of: current or predicted weather conditions for the AMS node, line-of-sight between the AMS node and the common source, or calculated gain for the AMS node.

5. The communication system of claim 1, wherein:
the AMS module includes a control service module configured to:
control antenna-to-antenna communication and antenna-to-common source communication; and
develop a communication approach to mitigate or eliminate antenna performance issues and/or antenna-to-common source connection issues.

6. The communication system of claim 5, wherein:
the control service module is configured to provide the communication approach via a user interface as a recommendation for mitigating or eliminating antenna performance issues and/or antenna-to-common source connection issues.

7. The communication system of claim 5, wherein:
the system is configured to implement the communication approach to mitigate or eliminate antenna performance issues and/or antenna-to-common source connection issues.

8. The communication system of claim 5, wherein:
the control service module is configured to assess a signal strength of an RF signal between an antenna and the common source; and/or
the control service module is configured to predict a signal strength of an RF signal to occur between an antenna and the common source.

9. The communication system of claim 5, wherein the plurality of AMS nodes includes:
a first AMS node having a first AMS module, a first control service module, and a first antenna;
a second AMS node having a second AMS module, a second control service module, and a second antenna
the first control service module is configured to assess and/or predict a signal strength of an RF signal between the first antenna and the common source; and/or
the second control service module is configured to assess and/or predict a signal strength of an RF signal between the second antenna and the common source.

10. The communication system of claim 5, wherein:
the control service module for each AMS node is configured to assess and/or predict a signal strength of an RF signal between any one or more of the plurality of antennas and the common source.

11. The communication system of claim 1, wherein:
the AMS module for each AMS node includes a control service module configured to: control antenna-to-antenna communication and antenna-to-common source communication and develop a communication approach to mitigate or eliminate antenna performance issues and/or antenna-to-common source connection issues;
the control service module for each AMS node is configured to assess and/or predict a signal strength of an RF signal between any one or more of the plurality of antennas and the common source;
wherein, when a signal strength between a first antenna of a first AMS node and the common source is assessed or predicted to be below a threshold signal strength, the control service module develops a communication approach that:
selects a second AMS node having an assessed or predicted signal strength that is equal to or greater than the threshold signal strength to communicate with the common source, wherein the first AMS node communicates with the common source via the second AMS node; or
selects a second AMS node such that a combined RF signal of the first AMS node and the second AMS node has an assessed or predicted signal strength that is equal to or greater than the threshold signal strength, wherein the first AMS node communicates with the common source via the combined RF signal of first and second AMS nodes.

12. The communication system of claim 11, wherein:
the system is configured to automatically implement the communication approach; or
the control service module is configured to transmit a recommendation message via a user interface, the recommendation message being the communication approach.

13. The communication system of claim 1, wherein:
the AMS module for each AMS node includes a control service module configured to: control antenna-to-antenna communication and antenna-to-common source communication and develop a communication approach to mitigate or eliminate antenna performance issues and/or antenna-to-common source connection issues;
the control service module for each AMS node is configured to assess and/or predict a signal strength of an RF signal between any one or more of the plurality of antennas and the common source;
wherein, when a signal strength between a first AMS node and the common source is assessed or predicted to be below a threshold signal strength, the control service module develops a communication approach that:
selects any one or more of the AMS nodes of the plurality of AMS nodes having an assessed or predicted signal strength that is equal to or greater than the threshold signal strength to communicate with the common source, wherein the first AMS node communicates with the common source via the selected any one or more AMS nodes; or
selects any one or more of the AMS nodes of the plurality of AMS nodes such that a combined RF signal of the first AMS node and the selected any one or more AMS nodes has an assessed or predicted signal strength that is equal to or greater than the threshold signal strength, wherein the first AMS node communicates with the common source via the combined RF signal of first AMS node and the selected any one or more AMS nodes.

14. The communication system of claim 13, wherein:
the control service module for each AMS node is configured to continuously, periodically, or at a scheduled time assess or predict a signal strength of an RF signal between any one or more of the plurality of AMS nodes and the common source.

15. A communication system, comprising:
a first remote node, a beyond line of site (BLOS) node, and a network of a plurality of antenna management system (AMS) nodes connected in a distributed manner, wherein:
the first remote node is configured to communicate with a second remote node via the BLOS node, the first remote node including an antenna compute capability, and a transceiver;
the BLOS node is configured as a relay or a repeater, the BLOS node including an antenna, compute capability, and a transceiver;
each AMS node of the network is connected to the second remote node, and each AMS node has an antenna, compute capability, and a transceiver; and
each of the first remote node, the BLOS node, and AMS node of the network includes an AMS module, wherein:
each antenna is configured to digitize a radio frequency (RF) signal when received by the antenna to generate digital data;
each compute capability is configured to time stamp the digital data; and
each compute capability is configured to process the time-stamped digital data to determine connectivity options.

16. The communication system of claim 15, wherein:
each AMS module includes a control service module configured to:
control antenna-to-antenna communication and antenna-to-second remote node communication; and
develop a communication approach to mitigate or eliminate antenna performance issues and/or antenna-to-second remote node connection issues.

17. The communication system of claim 16, wherein:
the control service module for the BLOS node is configured to assess and/or predict a signal strength of an RF signal between the BLOS node and the second remote node;
each control service module for each AMS node of the network is configured to assess and/or predict a signal strength of an RF signal between any one or more of the plurality of antennas of the AMS nodes and the BLOS node as well as the second remote node;
when a signal strength between a BLOS node antenna and the second remote node antenna is assessed or predicted to be below a threshold signal strength, the control service module develops a communication approach that:
selects any one or more AMS nodes of the network having an assessed or predicted signal strength that is equal to or greater than the threshold signal strength to communicate with the second remote node, wherein the BLOS node antenna communicates with the second remote node antenna via the selected any one or more of antennas, wherein the first remote node antenna communicates with the second remote node antenna via the BLOS node antenna; or
selects any one or more AMS nodes from the network such that a combined RF signal of the BLOS node antenna and the selected any one or more of AMS node antennas has an assessed or predicted signal strength that is equal to or greater than the threshold signal strength, wherein the BLOS node antenna communicates with the second remote node antenna via the combined RF signal of BLOS and selected any one or more antennas, wherein the first remote node antenna communicates with the second remote node antenna via the BLOS node antenna.

18. A method of managing communications in a communication system including a network having a plurality of antenna management system (AMS) nodes connected in a distributed manner, each AMS node including an antenna, compute capability, a transceiver, and an AMS module, the method comprising:
digitizing a radio frequency (RF) signal when received by the antenna from a common source to generate digital data;
time stamping the digital data; and
processing the time-stamped digital data to determine connectivity options.

19. The method of claim 18, further comprising:
registering an AMS node for inclusion into the network based on reachability of another AMS node;
assessing availability of an AMS node of the plurality of AMS nodes by factoring any one or combination of: current or predicted weather conditions for the antenna node; line-of-sight between the antenna node and the common source; or calculated gain for the antenna node; and
developing a communication approach to mitigate or eliminate antenna performance issues and/or antenna-to-common source connection issues by controlling antenna-to-antenna communication and antenna-to-common source communication.

20. The method of claim 19, further comprising:
providing the communication approach via a user interface as a recommendation for mitigating or eliminating antenna performance issues and/or antenna-to-common source connection issues; or
implementing the communication approach to mitigate or eliminate antenna performance issues and/or antenna-to-common source connection issues.
